(19) United States
(12) Patent Application Publication
(10) Pub. No.: US 2013/0254084 A1
(43) Pub. Date: Sep. 26, 2013

(54) SYSTEM AND METHOD FOR EFFECTIVE INTEREST RATE CALCULATION

(71) Applicant: E. Keith Darrow, Glenside, PA (US)

(72) Inventor: E. Keith Darrow, Glenside, PA (US)

(21) Appl. No.: 13/731,083

(22) Filed: Dec. 30, 2012

Related U.S. Application Data
(60) Provisional application No. 61/581,189, filed on Dec. 29, 2011.

(51) Int. Cl. G06Q 40/00

(52) U.S. Cl. CPC G06Q 40/00
USPC 705/35

(57) ABSTRACT

Systems and methods can quickly and easily compute an effective interest-rate calculation, such as an annual-percentage rate (APR), offered in connection with a credit-card balance-transfer promotion. The systems and methods fully automate the process, allowing a consumer to instantly solve an effective rate on a credit card balance transfer offer with no special knowledge or skills. The process can work with all or some of the variables, in any order. The consumer can use the tool to see how the variables of the offer alter the effective annual effective percentage rate, enabling the consumer to better shop and compare credit card balance transfer offers.

### CROSS-REFERENCE TO RELATED APPLICATION

This application claims the benefit of priority of U.S. provisional application No. 61/581,189, filed Dec. 29, 2011, the contents of which are herein incorporated by reference.

### BACKGROUND OF THE INVENTION

The present invention relates to computational systems and methods and more particularly, to systems and methods for the computation of an effective interest rate calculation relating to credit card balance transfer offers.

Currently, there is no established methodology for a consumer to calculate the effective interest rate on a credit card balance transfer. Very few people have a strong comprehension of finance math and even fewer can create a unique formula and methodology to make such a calculation.

The result is most consumers agree to credit card balance transfer offers and have no idea as to the effective annual percentage rate. Some promotions involve an offer for a low interest rate (or even zero percent) on balance transfer, which rate typically lasts between three months to a year, at which time the interest rate on any existing transferred balance increases. Some promotions include a transaction fee, typically from about 3 percent to about 5 percent of the balance transfer amount, for the privilege of transferring a balance to a credit card and/or an annual or membership fee.

Due to the number of variables, each offer can be very different and unique, making it even more challenging for the consumer. At present, a person would need to be skilled at university level finance math and have the vision to create a formula to make a decision if a credit card balance transfer offer is worth consideration. Typically, this requires a great deal of time and effort.

As can be seen, there is a need for a system and method for determining an effective interest rate for credit card balance transfer offers.

### SUMMARY OF THE INVENTION

In one aspect of the present invention, a method for calculating an effective interest rate for a loan comprises inputting discount percentage, loan rate, loan amount, loan begin date and loan end date into a computing device; computing, with the computing device, an amount to pay back, A, by the following formula:

$$A = Loan Amount * {( 1 + \frac{APR}{365} )}^{Duration of Loan i n Days} ;$$

computing, with the computing device, an amount borrowed after a deduction of a discount, B, by the following formula:

B=Loan Amount−(Loan Amount*Points); and

computing the effective interest rate, i, by the following formula:

$$i = 365 * [ \frac{log [ \frac{Loan Amount * {( 1 + \frac{APR}{365} )}^{Duration of Loan i n Days}}{Loan Amount - ( Loan Amount * Points )} ]}{{10}^{Duration of Loan i n Days}} - 1 ] ,$$

wherein the above formulas are specifically coded on the computing device so that A, B and i behave like fixed-point calculations.

These and other features, aspects and advantages of the present invention will become better understood with reference to the following description and claims.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides systems and methods for the computation of an effective interest-rate calculation, such as an annual-percentage rate (APR), offered in connection with a credit-card balance-transfer promotion. The systems and methods fully automate the process, allowing a consumer to instantly solve an effective rate on a credit card balance transfer offer with no special knowledge or skills. The process can work with all or some of the variables, in any order. The consumer can use the tool to see how the variables of the offer alter the effective annual effective percentage rate, enabling the consumer to better shop and compare credit card balance transfer offers.

A method of interest rate calculation consistent with a first exemplary embodiment of the present invention will now be described. In this embodiment, a financial calculator (e.g., HP 19BII Business Consultant II Financial Calculator) is employed to perform the calculations. This calculator has 6 gray colored soft keys running across the top of the keyboard. The functions of these keys vary depending on the mode in which the user is operating (e.g., “Fin,” “Bus,” “Sum,” etc.).

The calculator is turned on, and then the “Fin” mode is entered by pressing the gray soft key with “Fin” displayed on the bottom of the LCD screen above it. The screen then displays “TVM, IConv, Bond, Deprc.” TVM is selected by pressing the corresponding gray soft key on the calculator. The calculator displays the following screen, where horizontal lines represent the top and bottom of the calculator screen, and the six spaced equals signs (=) represent the gray soft keys on the calculator that change depending on the current mode of the calculator:

| | |
|---|---|
| 365 PMTS/YR: | End Mode |

| N | I % YR | PV | PMT | FV | Other |
|---|---|---|---|---|---|
| = | = | = | = | = | = |

In this example, the following balance-transfer offer parameters will be used:

Balance transfer offer of less than 1 year

Balance Transfer Fee of 3%

APR (Annual Percentage Rate) of 5.99%

Loan Amount of $10,000

Loan Begins May 1, 2010

Loan Ends Nov. 30, 2010

### First Calculation:

Loan amount of $10,000*3% balance transfer fee=$300.00

### Second Calculation:

The $300.00 result from the first calculation is used in the second calculation, as follows:

Loan Amount $10,000−$300.00 balance transfer fee=$9700.00 PV (Present Value).

The $9700.00 PV amount from the second calculation will be used in the fifth calculation. This number should be a negative, since PV in this case is negative in this type of calculation. Since $10,000−$300.00 equals a positive number, i.e., $9700.00, the sign of the result needs to be changed before the PV can be used in the fifth calculation (i.e., −$9700.00).

### Third Calculation:

May 1, 2010−Nov. 30, 2010=214 days=N(Number of payments).

(Financial calculator should be set to number of payments per year=365).

### Fourth Calculation:

In this calculation a financial calculator is used to obtain the result. This is not a final result, since this data will be stored for later use. The following values are inputted into the calculator, and the calculator solves for future value:

N=214,I % YR=5.99%,PV=−10,000.

The future value is computed by the calculator to be $10357.4044 and represents the amount of money the borrower will need to pay back. The following is displayed on the screen of the calculator after entering the values for N, I % YR, and PV:

| N = 214 | I % YR = 5.99% | PV = −10,000 | FV |
|---|---|---|---|
| = | = | = | = |

The user entered the beginning and ending dates of the loan, and the number of days between those two dates is calculated and stored as the number of days, N. The value of I % YR is provided by the user and is the APR stated on the loan, line of credit, or credit card offer. The value of PV is provided by the user and is the amount of the loan. The value of PV should be negative, and therefore, the sign of PV is changed after the user enters the value.

When the soft key under “FV” is pressed after entering the values of N, I % YR, and PV, the calculator solves for FV, which is the amount that will be owed to the bank at the end of 214 days at a 5.99% APR, based upon a $10,000.00 loan amount. In this example, the FV is calculated to be $10357.4044, and that number will be used in the fifth calculation.

### Fifth Calculation:

The financial calculator is used to obtain the result of the fifth calculation. This is accomplished by entering the values for N, PV, and FV into the calculator and solving for I % YR. The following is displayed on the screen of the calculator after entering the values for N, PV, and FV:

| N = 214 | I % YR | PV = −9700 | FV = 10357.4044 |
|---|---|---|---|
| = | = | = | = |

The value of N=214 was obtained from the third calculation, the value of PV=−9700 was obtained from the second calculation, and the value of FV=10357.4044 was obtained from the fourth calculation.

When the soft key under “I % YR” is pressed after entering the values of N, I % YR, and PV, the calculator solves for I % YR, which is the result of the fifth and final calculation and is dubbed the “Real Feel Rate.” In this example, a value of 11.1864% is displayed to the user as I % YR, the “Real Feel Rate.”

Since the foregoing multi-step calculations are prone to user error when performed on a financial calculator, a single complete formula can be derived that automatically determines effective APR using the smallest number of user-limited inputs. To achieve this, in a second exemplary embodiment of the invention, the “Real Feel Rate” is calculated using custom software running on a computer, such as a PC, or a remote server in an application service provider (ASP) model, based on user-supplied values as input.

An exemplary screen view of such software, showing the inputs (discount points or balance transfer fee percentage, loan rate, loan amount, and date parameters) and output result (effective APR), might appear as follows:

| | |
|---|---|
| Discount Percentage | 3% |
| Loan Rate | 5.99% |
| Loan Amount | $10,000.00 |
| Loan Begin Date | May 1, 2012 |
| Loan End Date | Nov. 30, 2012 |

Effective Annual Percentage Rate: 11.19%

The following steps are performed by the custom software, after the appropriate input values for variables are provided by the user:

1. The amount to pay back is represented by the variable A, which is calculated as follows:

$$A = Loan Amount * {( 1 + \frac{APR}{365} )}^{Duration of Loan i n Days} .$$

2. The amount borrowed after the deduction of points is represented by the variable B, which can be calculated as follows.

B=Loan Amount−(Loan Amount*Points).

3. The same formula as in step 1 is used for step 3, except that the loan amount is B, and instead of APR, the variable i will be used to represent the effective interest rate, which is the variable that will be solved for, as follows:

Divide both sides by the Duration of Loan in Days.

$$\frac{log ( \frac{A}{B} )}{Duration of Loan in Days} = log ( 1 + \frac{i}{365} )$$

Rewrite the logarithmic equation as an exponential operation.

$$\frac{log ( \frac{A}{B} )}{{10}^{Duration of Loan i n Days}} = log ( 1 + \frac{i}{365} )$$

Subtract 1 from both sides.

$$\frac{log ( \frac{A}{B} )}{{10}^{Duration of Loan i n Days}} - 1 = \frac{i}{365}$$

Multiply both sides by 365.

$$365 * ( \frac{log ( \frac{A}{B} )}{{10}^{Duration of Loan i n Days}} - 1 ) = i$$

Reverse the sides of the equation.

$$i = 365 * ( \frac{log ( \frac{A}{B} )}{{10}^{Duration of Loan i n Days}} - 1 )$$

4. Now, the values of A and B are substituted into the “generic” formula below to obtain the value for i.

$$i = 365 * [ \frac{log [ \frac{Loan Amount * {( 1 + \frac{APR}{365} )}^{Duration of Loan i n Days}}{Loan Amount - ( Loan Amount * Points )} ]}{{10}^{Duration of Loan i n Days}} - 1 ]$$

It is noted that all the variables in the generic formula are within the exponent of 10. The exponent of 10 is a fraction, and the numerator of the fraction is also a fraction, and so there is a fraction within a fraction. Also, in the numerator of the fraction within the fraction, there is another exponent, and so there is also an exponent within an exponent.

Using the variables in the numerical example above, the generic formula can be used to calculate the value of i as follows:

i=365*(10̂ log((10000*(1+(0.0599/365))̂214)/(10000−(10000*0.03)))/214)−1), or

i=0.1118636757.

It should be understood that inserting the foregoing generic formula into a spreadsheet (e.g., Microsoft Excel), PC- or Mac-based calculator, or smartphone operating system (e.g., iOS or Android) calculator, will not result in the correct effective APR. This is due to exponential errors resulting from floating-point numbers used to perform the calculations. Accordingly, below is a sample of pseudocode showing how the formula can be specifically coded so that the numbers being computed behave like fixed-point calculations, e.g., as might be handled by a high-precision hand-held calculator, such as the HP 19BII. When implemented in this manner, the formula can execute with complete accuracy and simplicity on PCs, Macs, smartphones, handheld computing devices, and other computing devices.

An exemplary pseudocode sample showing the implementation of the generic formula on a PC, Mac, and/or handheld computers is provided below:

```
protected void Page_Load(object sender, EventArgs e)
{
  double loanAmount = Convert.ToDouble(Request[“loanAmount”]);
  double apr = Convert.ToDouble(Request[“aprPercent”]);
  double duration = Convert.ToDouble(Request[“duration”]);
  double points = Convert.ToDouble(Request[“balancePercent”]);
  double answer;
  double futureValue;
  double presentValue;
  futureValue = calcFutureValue(loanAmount, apr, duration, 365);
  presentValue = −1 * (loanAmount − (loanAmount * (points/100)));
  double thePV = presentValue;
  double theFV = futureValue;
  double theC = 365;
  answer = calcNR(thePV, theFV, duration, theC);
}
public double calcPV(double inFV, double interestRate, double inNP,
double compoundPeriod) {
  var inPMT = 0;
  var outPV = inFV*Math.Pow((1 + interestRate/(100*
compoundPeriod)), (−inNP));
  if (interestRate == 0) {
    outPV = outPV + inPMT*inNP;
  } else {
    outPV = outPV + inPMT*((1−(Math.Pow((1 + interestRate /
  (100*compoundPeriod)),(−inNP))))/(interestRate/(100*
  compoundPeriod)));
    }
    return outPV;
  }
public double calcFutureValue(double inPV, double interestRate, double
inNP, double compoundPeriod) {
  var inPMT = 0;
  var outFV = inPV*Math.Pow((1 + interestRate/
(100*compoundPeriod)),(inNP));
  if (interestRate == 0) {
    outFV = outFV + inPMT*inNP;
  } else {
    outFV = outFV + inPMT*((Math.Pow((1 + interestRate/ (100*
  compoundPeriod)),(inNP)) −1)/(interestRate/(100*compoundPeriod)));
    }
    return outFV;
  }
public double calcNR(double inPV, double inFV, double inNP, double
compoundPeriod) {
  double outNR = 0.1; // initial guess
  double thePV1, thePV2, theDeriv;
  double theH = 0.00001;
  double i = 1;
  double theZeros = 0;
  double lastNR = outNR;
  if (inNP <= 0) { // should throw an exception
    Response.Write(“You forgot to enter an APR rate”);
    return outNR = 0;
  }
  if (inFV == 0) {
    theZeros++;
}
  if (inPV == 0) {
    theZeros++;
    // inFV *= −1;
  }
  if (theZeros >= 2) { // should throw an exception
    Response.Write(“1”);
    return 0;
  }
  /*if ((inPV > 0) && (inFV >= 0)) {
    alert(“2”);
    return 0;
  }*/
  if ((inPV == 0) && (inFV >= 0)) {
    Response.Write(“3”);
    return 0;
  }
  inPV *= −1;
  do {
    thePV1 = calcPV(inFV,(outNR*100),inNP,compoundPeriod) −
  inPV;
    theDeriv = ((calcPV(inFV,((outNR+theH)
  *100),inNP,compoundPeriod) − inPV) − thePV1)/theH;
    thePV2 = thePV1;
    lastNR = outNR;
    outNR = outNR − thePV1/theDeriv;
    if (i > 200) { // should throw an exception
      Response.Write(“4”);
      return 0;
    }
    i++;
    if (thePV2 < 0) thePV2 *= −1;
  } while (thePV2 > 0.0001);
  return (lastNR*100); // maybe should change to give the previous rate
}
```

It should be recognized that, despite the existence of countless PC/Mac/smartphone financial calculator applications available for purchase and download, none of these applications are properly “tuned” to provide a completely accurate result to the user, i.e., such applications “float the numbers” in their equations, giving a less accurate result. In a scheme consistent with embodiments of the present invention, special coding, such as in the example shown above, is used to provide specificity for solving the effective APR of a credit-card balance-transfer offer.

Additionally, embodiments of the invention use days, instead of months, as the base unit of time in the time value of money (TVM) equations. Months are commonly used in the credit-card industry as the base unit of time for calculating the cost of money for loans. Car loans are normally offered in 36-, 48-, and 60-month periods. Home loans are normally offered as 15-year or 30-year loans, but typically, months are still used as the underlying units of time. Credit-card balance-transfer offers do not typically begin and end at the beginning, middle, or end of a month, as would be the case with a mortgage or other formal loan. Using days as the base unit in embodiments of the invention provides unique advantages of specificity and accuracy relative to the use of months or years when performing calculations for a balance transfer offer. Without a system consistent with embodiments of the invention, a user could have no more than a general idea, at best, of the true cost of the money borrowed via the balance transfer. However, by using days as units, and including a days-between-dates calculator into an application consistent with embodiments of the invention, the user can instantly calculate any combination of days, months, and years, enabling the calculator to be infinitely versatile for balance transfer offers and many other types of advance-pay loans, such as automobile leases, mortgage with points and fees, and the like. By being able to use days-between-dates calculations in an application consistent with embodiments of the invention, the user does not need any particular skill or knowledge to obtain expert information about credit-card balance-transfer offers and other loan offers of interest to the user.

### Alternative Embodiments

It should be understood that various changes in the details, materials, and arrangements of the parts which have been described and illustrated in order to explain the nature of this invention may be made by those skilled in the art without departing from the scope of the invention.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing embodiments of the invention. The present invention can also be embodied in the form of program code, for example, stored in a non-transitory machine-readable storage medium including being loaded into and/or executed by a machine, wherein, when the program code is loaded into and executed by a machine, such as a computer, the machine becomes an apparatus for practicing embodiments of the invention. When implemented on a general-purpose processor, the program code segments combine with the processor to provide a unique device that operates analogously to specific logic circuits.

It will be appreciated by those skilled in the art that although the functional components of the exemplary embodiments of the system of the present invention described herein may be embodied as one or more distributed computer program processes, data structures, dictionaries and/or other stored data on one or more conventional general-purpose computers (e.g., IBM-compatible, Apple Macintosh, and/or RISC microprocessor-based computers), mainframes, minicomputers, conventional telecommunications (e.g., modem, T1, fiber-optic line, DSL, satellite and/or ISDN communications), memory storage means (e.g., RAM, ROM) and storage devices (e.g., computer-readable memory, disk array, direct access storage) networked together by conventional network hardware and software (e.g., LAN/WAN network backbone systems and/or Internet), other types of computers and network resources may be used without departing from the present invention. One or more networks discussed herein may be a local area network, wide area network, internet, intranet, extranet, proprietary network, virtual private network, a TCP/IP-based network, a wireless network (e.g., IEEE 802.11 or Bluetooth), an e-mail based network of e-mail transmitters and receivers, a modem-based, cellular, or mobile telephonic network, an interactive telephonic network accessible to users by telephone, or a combination of one or more of the foregoing.

Embodiments of the invention as described herein may be implemented in one or more computers residing on a network transaction server system, and input/output access to embodiments of the invention may include appropriate hardware and software (e.g., personal and/or mainframe computers provisioned with Internet wide area network communications hardware and software (e.g., CQI-based, FTP, Netscape Navigator™, Mozilla Firefox™, Microsoft Internet Explorer™, or Apple Safari™ HTML Internet browser software, and/or direct real-time or near-real-time TCP/IP interfaces accessing real-time TCP/IP sockets) for permitting human users to send and receive data, or to allow unattended execution of various operations of embodiments of the invention, in real-time and/or batch-type transactions. Likewise, the system of the present invention may include one or more remote Internet-based servers accessible through conventional communications channels (e.g., conventional telecommunications, broadband communications, wireless communications) using conventional browser software (e.g., Netscape Navigator™, Mozilla Firefox™, Microsoft Internet Explorer™, or Apple Safari™). Thus, the present invention may be appropriately adapted to include such communication functionality and Internet browsing ability. Additionally, those skilled in the art will recognize that the various components of the server system of the present invention may be remote from one another, and may further include appropriate communications hardware/software and/or LAN/WAN hardware and/or software to accomplish the functionality herein described.

Each of the functional components of the present invention may be embodied as one or more distributed computer-program processes running on one or more conventional general purpose computers networked together by conventional networking hardware and software. Each of these functional components may be embodied by running distributed computer-program processes (e.g., generated using “full-scale” relational database engines such as IBM DB2™, Microsoft SQL Server™, Sybase SQL Server™, or Oracle 10g™ database managers, and/or a JDBC interface to link to such databases) on networked computer systems (e.g., including mainframe and/or symmetrically or massively-parallel computing systems such as the IBM SB2™ or HP 9000™ computer systems) including appropriate mass storage, networking, and other hardware and software for permitting these functional components to achieve the stated function. These computer systems may be geographically distributed and connected together via appropriate wide- and local-area network hardware and software. In one embodiment, data stored in the database or other program data may be made accessible to the user via standard SQL queries for analysis and reporting purposes.

Primary elements of embodiments of the invention may be server-based and may reside on hardware supporting an operating system such as Microsoft Windows NT/2000™ or UNIX.

Components of a system consistent with embodiments of the invention may include mobile and non-mobile devices. Mobile devices that may be employed in the present invention include personal digital assistant (PDA) style computers, e.g., as manufactured by Apple Computer, Inc. of Cupertino, Calif., or Palm, Inc., of Santa Clara, Calif., and other computers running the Android, Symbian, RIM Blackberry, Palm webOS, or iPhone operating systems, Windows CE™ handheld computers, or other handheld computers (possibly including a wireless modem), as well as wireless, cellular, or mobile telephones (including GSM phones, J2ME and WAP-enabled phones, Internet-enabled phones and data capable smart phones), one- and two-way paging and messaging devices, laptop computers, etc. Other telephonic network technologies that may be used as potential service channels in a system consistent with embodiments of the invention include 2.5G cellular network technologies such as GPRS and EDGE, as well as 3G technologies such as CDMA1xRTT and WCDMA2000, and 4G technologies. Although mobile devices may be used in embodiments of the invention, non-mobile communications devices are also contemplated by embodiments of the invention, including personal computers, Internet appliances, set-top boxes, landline telephones, etc. Clients may also include a PC that supports Apple Macintosh™, Microsoft Windows 95/98/NT/ME/CE/2000/XP/Vista/7™, a UNIX Motif workstation platform, or other computer capable of TCP/IP or other network-based interaction. In one embodiment, no software other than a web browser may be required on the client platform.

Alternatively, the aforesaid functional components may be embodied by a plurality of separate computer processes (e.g., generated via dBase™, Xbase™, MS Access™ or other “flat file” type database management systems or products) running on IBM-type, Intel Pentium™ or RISC microprocessor-based personal computers networked together via conventional networking hardware and software and including such other additional conventional hardware and software as may be necessary to permit these functional components to achieve the stated functionalities. In this alternative configuration, since such personal computers typically may be unable to run full-scale relational database engines of the types presented above, a non-relational flat file “table” (not shown) may be included in at least one of the networked personal computers to represent at least portions of data stored by a system according to the present invention. These personal computers may run the Unix, Microsoft Windows NT/2000™ or Windows 95/98/NT/ME/CE/2000/XP/Vista/7™ operating systems. The aforesaid functional components of a system according to the present invention may also include a combination of the above two configurations (e.g., by computer program processes running on a combination of personal computers, RISC systems, mainframes, symmetric or parallel computer systems, and/or other appropriate hardware and software, networked together via appropriate wide- and local-area network hardware and software).

A system according to the present invention may also be part of a larger system including multi database or multi-computer systems or “warehouses” wherein other data types, processing systems (e.g., transaction, financial, administrative, statistical, data extracting and auditing, data transmission/reception, and/or accounting support and service systems), and/or storage methodologies may be used in conjunction with those of the present invention to achieve additional functionality.

In one embodiment, source code may be written in an object-oriented programming language using relational databases. Such an embodiment may include the use of programming languages such as C++ and toolsets such as Microsoft's .Net™ framework. Other programming languages that may be used in constructing a system according to the present invention include Java, HTML, Perl, UNIX shell scripting, assembly language, Fortran, Pascal, Visual Basic, and QuickBasic. Those skilled in the art will recognize that the present invention may be implemented in hardware, software, or a combination of hardware and software.

Accordingly, the terms “computer” or “system,” as used herein, should be understood to mean a combination of hardware and software components including at least one machine having a processor with appropriate instructions for controlling the processor. The terms “computer” or “system” can be used to refer to more than a single computing device, e.g., multiple personal computers, or one or more personal computers in conjunction with one or more other devices, such as a router, hub, packet inspection appliance, firewall, etc.

It should also be appreciated from the outset that one or more of the functional components may alternatively be constructed out of custom, dedicated electronic hardware and/or software, without departing from the present invention. Thus, the present invention is intended to cover all such alternatives, modifications, and equivalents as may be included within the spirit and broad scope of the invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments.

It should be understood, of course, that the foregoing relates to exemplary embodiments of the invention and that modifications may be made without departing from the spirit and scope of the invention as set forth in the following claims.

What is claimed is:

1. A method for calculating an effective interest rate for a loan, the method comprising:
inputting discount percentage, loan rate, loan amount, loan begin date and loan end date into a computing device;
computing, with the computing device, an amount to pay back, A, by the following formula:
$$A = Loan Amount * {( 1 + \frac{APR}{365} )}^{Duration of Loan i n Days}$$
computing, with the computing device, an amount borrowed after a deduction of a discount, B, by the following formula:
B=Loan Amount−(Loan Amount*Points)
computing the effective interest rate, i, by the following formula:
$$i = 365 * [ \frac{log [ \frac{Loan Amount * {( 1 + \frac{APR}{365} )}^{Duration of Loan i n Days}}{Loan Amount - ( Loan Amount * Points )} ]}{{10}^{Duration of Loan i n Days}} - 1 ] ,$$
wherein the above formulas are specifically coded on the computing device so that A, B and i behave like fixed-point calculations.

2. The method of claim 1, wherein the computing device is selected from the group consisting of a desktop computer, a tablet computer, a laptop computer, a web-based server, and a smartphone.

3. The method of claim 1, wherein the steps are coded in programming code, disposed in a non-transitory medium.

4. The method of claim 3, wherein the programming code is a smartphone application.

5. The method of claim 3, wherein the programming code is accessed via a web-based interface.

6. The method of claim 1, wherein the loan is a credit card balance transfer offer.

7. Software written in programming code disposed on a non-transitory computer readable medium, the programming code having program code segments for performing the following steps:
receiving an input from a user concerning a loan, the input including loan discount percentage, loan rate, loan amount, loan begin date and loan end date;
computing an amount to pay back, A, by the following formula:
$$A = Loan Amount * {( 1 + \frac{APR}{365} )}^{Duration of Loan i n Days}$$
Computing an amount borrowed after a deduction of a discount, B, by the following formula:
B=Loan Amount−(Loan Amount*Points)
computing the effective interest rate, i, by the following formula:
$$i = 365 * [ \frac{log [ \frac{Loan Amount * {( 1 + \frac{APR}{365} )}^{Duration of Loan i n Days}}{Loan Amount - ( Loan Amount * Points )} ]}{{10}^{Duration of Loan i n Days}} - 1 ] ,$$
wherein the above formulas are specifically coded so that A, B and i behave like fixed-point calculations.

8. The software of claim 7, wherein the software is loaded on a computing device, the computing device is selected from the group consisting of a desktop computer, a tablet computer, a laptop computer, a web-based server, and a smartphone.

9. The software of claim 7, wherein the programming code is a smartphone application.

10. The software of claim 7, wherein the loan is a credit card balance transfer offer.
